(19) United States
(12) Patent Application Publication
(10) Pub. No.: US 2010/0212752 A1
(43) Pub. Date: Aug. 26, 2010

(54) Shut Off Protection For Hot Water Heater

(76) Inventor: Giovanni Fima, Oceanside, CA (US)

Correspondence Address: FISH & ASSOCIATES, PC;ROBERT D. FISH, 2603 Main Street, Suite 1000, Irvine, CA, 92614-6232, US

(21) Appl. No.: 12/391,018

(22) Filed: Feb. 23, 2009

(51) Int. Cl. G05D 16/00; B23P 19/04

(52) U.S. Cl. 137/87.03; 137/87.05; 29/700

(57) ABSTRACT

A system that shuts down water flow to a water heater of a residence or commercial building upon detecting a leak that includes first and second valves, and first and second valve actuators that operate to control the first and second valves, respectively. Preferred systems also include first and second sensors that measure the flow of water into and out from water heaters, respectively. Preferred systems further include controllers that receive signals from each of the first and second sensors. Such controllers controllably communicate with each of the first and second valve actuators to close the first and second valves, respectively, when a flow difference is detected that is greater than a predetermined threshold.

### FIELD OF THE INVENTION

The field of the invention is water heaters.

### BACKGROUND

Hot water heaters often develop leaks over time, which if they continue undetected can cause significant damage to a structure and its contents. Since water heaters typically lack any ability to detect leaks, such leaks often go unnoticed until significant damage occurs. Furthermore, while water heaters generally have a blow-out valve to prevent explosions, such valves tend to build-up lime and other mineral deposits over time, which can cause the valves to fail.

It is known to place sensors beneath water heaters to detect leaks. For example, U.S. Patent Appl. No. 2007/0261241 to Akkala, et al. discusses the use of such a sensor, which closes a valve to the water heater when the sensor detects water. One problem with the Akkala solution is that the sensors are typically placed underneath water heaters, which are generally located in an outdoor or semi-outdoor location and thus often corrode and malfunction. In addition, sensors positioned underneath a water heater often falsely trigger, such as from a small amount of water that might inadvertently come into contact with the sensors. Such sensors also fail to adequately monitor for leaks in tankless water heaters, as such water heaters typically are mounted to a wall, rather than a floor.

To eliminate the need for an external sensor, U.S. Pat. No. 4,118,780 to Hirano discusses using a pair of flow meters at the inlet and outlet to the tuyere of a blast furnace to monitor for water leakage by comparing the frequencies of the flow meters. However, one problem with the Hirano system is that it fails to automatically shut down the system when a leak is detected. In addition, the system fails to be user-installable, and instead requires trained technicians for installation.

Akkala, Hirano, and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Thus, there is still a need for a user-installable system that detects water leaks in a hot water heater and automatically shuts down the water heater when a leak is detected.

### SUMMARY OF THE INVENTION

The inventive subject matter provides systems and methods that seek to shut down water flow to a water heater of a residential, commercial, or other structure, when a leak is detected. Contemplated water heaters include storage water heaters, tankless or instantaneous water heaters, as well as all other commercially available water heaters. Preferred systems have first and second valves, as well as first and second valve actuators that operate the respective first and second valves. With first and second valves, the systems can advantageously stop the flow of water into and out of the water heater when a leak is detected, and thereby prevent further water leakage and damage. Preferred systems also have first and second sensors that measure a flow of water into and out of the water heater, respectively. A controller can advantageously receive a signal from each of the sensors, and communicates with each of the valve actuators.

All commercially suitable types of valves are contemplated for use in the system including for example, needle valves, ball valves, gate valves, poppet valves, plug valves, globe valves, butterfly valves, and diaphragm valves. However, as used herein the term “valve” excludes non-fluid “valves” such as diodes. It is further contemplated that at least one of the first and second valves could regulate flow in two or more directions using any commercially available design including for example, a two-way and a three-way design. Thus, for example, the second valve might have a two-way design that allows the valve to close the fluid outlet and open a drain outlet. The valves could be formed from any commercially practical material including for example, brass, stainless steel, plastic, ceramic, bimetals, and any combination thereof. Furthermore, the valve could be sized and dimensioned to conform to the pipe or other fluid conduit. Further, such valves preferably have an open bias (e.g., default to an open position).

Each of the first and second valve actuators could be of any commercially available design including for example, mechanical, magnetic (e.g., a solenoid), electric, pneumatic, and hydraulic. Thus, for example, the valve actuators could be of the same or different type. In addition to the valves being controlled by the automatic valve actuators, it is also contemplated that the valves could have a manual actuator to allow a user to manually open or close the valves. This is advantageous as the valve could be controlled automatically by a valve controller, but could also be manually controlled if needed (e.g., due to malfunctioning controller or a power outage).

The first and second sensors operate to measure the flow of water per unit of time. Any commercially available type of sensor that can measure the fluid flow within a pipe is contemplated including for example, thermal, electromagnetic (e.g., a turbine with a Hall's effect reader), mechanical (e.g., a vane), chemical, optical, ultrasonic, capacitance, inductive, and any combination thereof. For example, with a turbine flow sensor, the flow can be computed from the number of revolutions of the turbine per unit of time (e.g., revolutions per minute). Moreover, the first and second sensors could be of the same or different types. Further, the sensors could be disposed within or outside the pipe or other fluid conduit. In addition, the sensors could be disposed within the valves or valve actuators.

It is contemplated that additional sensors could be provided that measure at least one of a temperature or pressure within the water heater. Preferably, two additional sensors are provided to allow measurement of both temperature and pressure within the water heater. While the optional sensors could be disposed in any suitable location to detect the pressure and/or temperature within the water heater, preferably, the sensors are disposed on the water heater. Such additional sensors are advantageous as they provide a backup to the blowout valve should it fail to open. For example, as the blowout valve is typically constructed to open at a defined pressure (e.g., 150 psi), the controller is preferably programmed to shut down the water heater if the pressure sensor detects a pressure at least 2 psi greater than the pressure needed to open the blowout valve. Preferably, the controller is configured to shut down the water heater should the temperature sensor detect a temperature of greater than 130° C., more preferably greater than 120° C., and most preferably, greater than 100° C. In this manner, should the blowout valve fail to open, the water heater would be shut down before an explosion or other damage occurs to the water heater or surrounding structures. This is advantageous as it allows a user to keep the existing water heater and simply replace the failed blowout valve, thereby extending the life of the water heater. While specific pressures and temperatures have been given, it is contemplated that the temperature or pressure thresholds could be varied as needed. Unless a contrary intent is apparent from the context, all ranges recited herein are inclusive of their endpoints, and open-ended ranges should be interpreted to include only commercially practical values.

In one aspect, additional sensors could be provided that measure at least one of a temperature and pressure outside of the water heater or within a pipe or fluid conduit.

Others sensors could also be used with the system including for example, smoke detectors and earthquake sensors. Such sensors could be advantageous as they allow the water heater to be shut down in the event of a dangerous condition such as a fire or earthquake, and might thereby prevent possible water damage or explosions.

One or more of the sensors could additionally include electronics that filter, amplify, or convert a signal from the sensor to assist in the signal's interpretation. For example, the electronics could convert at least one of a measured flow rate, temperature, and pressure into an electrical signal. Alternatively, a device external to the sensor could convert the signal. For example, the device could be adjacent to the sensor or otherwise coupled to the sensor.

Additionally, all manner of commercially available electronics for conditioning signals are contemplated.

The controller could be integrated within the water heater, or be disposed in a separate housing. In one aspect, the controller is wall-mounted, and preferably is mounted to a power outlet. Preferably, the controller is disposed near the water heater, and more preferably within a range of no more than 6 feet from the water heater. However, the controller could be disposed on the water heater or in any practical location.

Preferably, the controller is user pluggable into a power grid. It is also contemplated that the controller could be hard-wired to the power grid or other power source including for example, a battery or solar panel. In addition, the controller could comprise electronics to allow it to communicate over a power line, such as by an IP over power line connection, the use of X10 modules, or any other commercially available connection. This is advantageous as it allows the controller to be user-installed, and provide power to the sensors and valve actuators. In addition, the controller could thereby communicate with a remote monitor over the power line without the need for additional wiring.

The controller is connected to the valve actuators and sensors in the system. While the controller could include electronics to allow it to communicate with the sensors and valve actuators using a wireless connection (e.g., WIFI, Bluetooth, or infrared or radio frequency), preferably a wired connection is used (e.g., one or more cables or other wires providing both power and data connections). The controller further includes electronics configured to receive a signal from at least the first and second sensors, as well as any additional sensors included in the system. In addition, the electronics are configured to allow the controller to communicate a signal to and thereby control one or more valve actuators.

The controller is preferably programmed to communicate with the first and second valve actuators to shut the first and second valves when a flow difference of a defined threshold is detected between the flows of water into and out of the water heater. Such a threshold could include a difference in flow rate (e.g., 1 gallon per minute), a flow difference occurring for greater than a defined period of time (e.g., 15 minutes), or a flow difference occurring for greater than a defined amount of water (e.g., 1 gallon). It is also contemplated that the controller could be programmed to shut the first and second valves if the optional pressure sensor detects a pressure within the water heater that is greater than the pressure needed to open a blowout valve, and preferably at least 2 psi greater than such pressure. However, lesser or greater thresholds are also contemplated. The controller could also be programmed to shut the first and second valves if the temperature sensor detects a temperature within the water heater that is greater than a defined threshold, including for example the temperature ranges discussed above.

The controller could be further programmed to interrupt at least one of a flow of gas and electricity to the water heater when the controller communicates with the first and second valve actuators to shut the first and second valves. This is advantageous as it helps prevent possible fires, explosions, or other problems that could occur when the water flow into and out of the water heater is stopped. The controller or thermocouple could interrupt the flow of gas by communicating with an optional third valve actuator to shut a third valve and thereby prevent gas flow to the water heater. It is also contemplated that the controller could interrupt electricity to the water heater through the use of a built-in switch or by communicating with an external switch to stop electricity to the water heater.

In one aspect, the controller could include a manual reset button that causes the controller to communicate with the first and second valve actuators to open the valves when the reset button is engaged. If the controller had previously stopped the flow of gas and/or electricity to the water heater, the controller could also be configured to cause the flow of gas and/or electricity to resume when the reset button is engaged. Optionally, the flow of gas and/or electricity could be resumed through the use of additional reset buttons or switches designed specifically to resume such flow. Such additional reset buttons or switches could be disposed on the controller or valve actuators.

In another aspect, a method is disclosed of retrofitting a tankless water heater coupled to an outlet valve, a first flow sensor, and electronics that controls flow to the water heater, and optionally having an outlet valve actuator. An inlet valve that regulates a flow of water into the water heater, and an inlet valve actuator that controls the inlet valve, are provided. A second flow sensor is also provided that measures the flow of water into the water heater. The inlet valve actuator and second flow sensor are coupled with the electronics of the water heater using a wired or wireless connection, with the electronics being programmed to process signals received from the first and second flow sensors, and to shut the inlet and outlet valves, and optionally the electricity or gas energy to the water heater, when a flow difference greater than a predetermined threshold is detected. Optionally, an embodiment is utilized in which the electronics is programmed to shut the inlet and outlet valves when a flow difference greater than a threshold flow rate (e.g., 2 gallons per minute) is detected. An embodiment could also be utilized in which the electronics is programmed to shut the inlet and outlet valves when a flow difference for greater than a threshold time period (e.g., 10 minutes) is detected. A further embodiment could be utilized in which the electronics is programmed to shut the inlet and outlet valves when a flow difference greater than a threshold amount of water (e.g., 2 gallons) is detected.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a diagram of a system for shutting down water flow to a storage water heater upon detecting a leak.

FIGS. 2A-2B are diagrams of systems for shutting down water flow to tankless water heaters upon detecting a leak.

FIG. 3 is an alternative diagram of a system for shutting down water flow to a storage water heater upon detecting a leak.

FIG. 4 is a flowchart of a method of retrofitting a tankless water heater to shut down water flow to the water heater upon detecting a leak.

### DETAILED DESCRIPTION

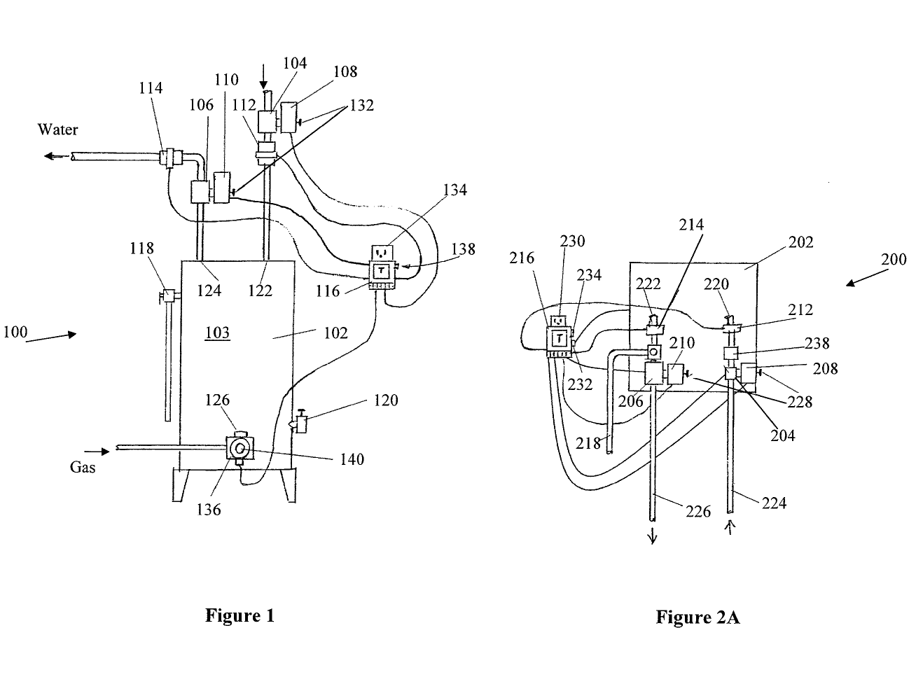

In FIG. 1, system 100 is designed to shut off water flow to a water heater 102 upon detection of a leak. System 100 includes first 104 and second valves 106, first 108 and second valve actuators 110, first 112 and second sensors 114, and a controller 116.

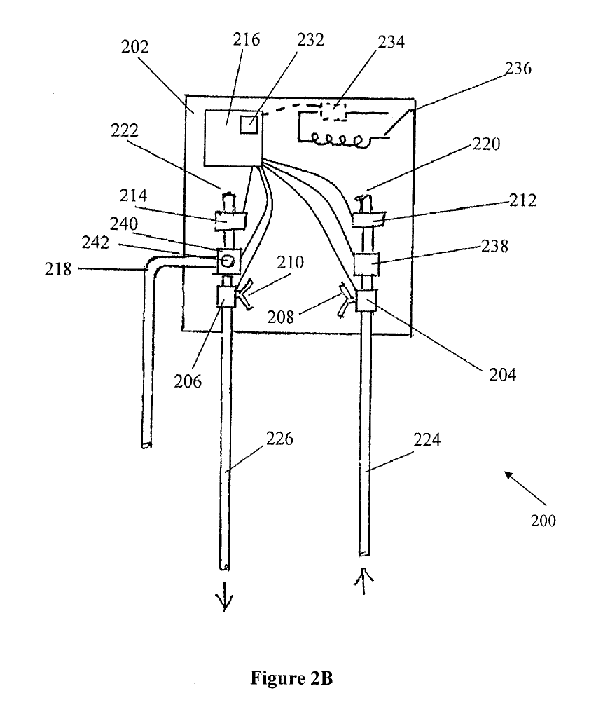

Water heater 102 has a storage tank 103 for storing hot water. However, system 100 is contemplated to work with any commercially available water heater including for example, tankless water heaters shown in FIGS. 2A-2B, as well as other water heaters and boilers. Water heater 102 includes blowout valve 118 and drain pipe 120. Preferably, blowout valve 118 comprises a check valve that opens at a defined pressure threshold. Water heater 102 also includes a fluid inlet 122 and a fluid outlet 124. Water heater 102 further includes gas inlet 126, though it is contemplated that other sources of energy could be used including for example, oil and electricity.

First 104 and second valves 106 are disposed on an inlet pipe or other conduit 122 and an outlet pipe or other conduit 124, respectively. First and second valves could be any commercially practical valve including for example, those discussed above. In addition, the first and second valves could be of the same or different valve types. For example, the first valve could be a ball valve, while the second valve could be a gate valve. While the first and second valves are shown regulating fluid flow in a straight-through design, it is contemplated that other designs could be used including for example, a two-way and a three-way design.

First 108 and second valve actuators 110 are operably connected to the first 104 and second valves 106, respectively, and automatically open or shut the valves when a signal is received from controller 116. All commercially suitable valve actuators are contemplated including for example, those discussed above. The first 108 and second valve actuators 110 are preferably positioned adjacent the first 104 and second valves 106, respectively. Optionally, at least one and preferably both of the first 104 and second valves 106 include manual valve actuator 132, such as a dial or lever that assists in manually opening or shutting the valve. Preferably, the valve actuators 108 and 110 comprise circuitry configured to receive a signal from the controller and open or close the valve upon receipt of the signal.

First 112 and second sensors 114 measure the amount of fluid flow within the inlet 122 and outlet pipes 124 per defined time period. First 112 and second sensors 114 could comprise any commercially available sensor including for example, those discussed above. First 112 and second sensors 114 are disposed adjacent to the first 104 and second valves 106, respectively. However, it is also contemplated that one or both of the first and second sensors could be disposed within the first and second valves, respectively, or elsewhere along the fluid pipe or conduit. In addition, while the first 112 and second sensors 114 are shown disposed within the pipe, the sensors could be disposed in any location suitable to measure the fluid flow. The sensors could optionally include electronics that filter, amplify, or convert a signal from the sensor to assist in the signal's interpretation.

Controller 116 receives a signal from each of the first 112 and second sensors 114, and controllably communicates with each of the first 108 and second valve actuators 110. As shown in FIG. 1, controller 116 is hard-wired to each of the sensors 112 and 114 and valve actuators 108 and 110. A wired connection is advantageous as it allows controller 116 to communicate and power each of the devices 108-114. However, it is also contemplated that the controller could wirelessly communicate with at least one of the sensors and valve actuators. In addition, controller could have additional electronics (not shown) to allow the controller to communicate over a power line, such as by an IP over power line connection, the use of X10 modules, or any other commercially available connection.

Controller 116 is user-pluggable into a power outlet 134, and thereby connects to a power grid. Optionally, screws or other fasteners (not shown) could be used to securely mount the controller to the power outlet. It is also contemplated that the controller could be mounted on the water heater or disposed in a separate housing. In further contemplated embodiments, the controller could be hard-wired to a power grid or other power source (not shown), including for example, a battery or solar panel. Controller 116 is shown disposed near water heater 102, and is preferably disposed within a range of no more than 6 feet from water heater 102. However, it is contemplated that the controller could be mounted in any practical location.

Controller 116 is preferably programmed to communicate with first 108 and second valve actuators 110 to shut the first 104 and second valves 106 when a flow difference of a defined threshold is detected between the flows of water into and out of water heater 102. Controller 116 is further programmed to communicate with a third valve actuator 136 to interrupt a flow of gas to water heater 102 when a flow difference of a defined threshold is detected. It is also contemplated that the controller could interrupt electricity to the water heater a shown in FIG. 2A.

Controller 116 further includes a manual reset button 138 that causes controller 116 to communicate with first 108 and second valve actuators 110 to open the valves 104 and 106 when reset button 138 is engaged. While the manual reset is shown as a button, it could also be a switch or other toggle. Reset button 138 also preferably causes controller 116 to communicate with third valve actuator 136 to open the third valve 140 when reset button 138 is engaged. Optionally, additional reset buttons or switches (not shown) could be disposed on the controller, valves, or valve actuators.

In FIG. 2A-2B, system 200 is shown that shuts down water flow to tankless water heater 202 upon detecting a leak. The system includes first 204 and second valves 206, first 208 and second valve actuators 210, first 212 and second sensors 214, and a controller 216. Water heater 202 includes drain pipe 218. First 204 and second valves 206 are disposed on an inlet pipe 224 and an outlet pipe 226, respectively. The inlet pipe 224 and the outlet pipe 226 connect to a fluid inlet 220 and a fluid outlet 222 of the water heater 202, respectively. First 208 and second valve actuators 210 are operably connected to first 204 and second valves 206, respectively, and comprise circuitry (not shown) that receives a signal from the controller 216 and automatically opens or closes the valves 204 and 206 upon receipt of the signal. At least one, and preferably both, of first 204 and second valves 206 include manual valve actuator 228.

As shown in FIG. 2A, controller 216 is user-pluggable into a power outlet 230 and thereby connects to a power grid. However, controller 216 could also be integrated into water heater 202 as shown in FIG. 2B. Controller 216 is preferably programmed to communicate with first 208 and second valve actuators 210 to shut the first 204 and second valves 206 when a flow difference of a defined threshold is detected between the flows of water into and out of water heater 202. Controller 216 is further programmed to communicate with a switch 232 to interrupt electricity to the water heater 202 when a flow difference of a defined threshold is detected. It is also contemplated that controller 216 could interrupt electricity to water heater 202 by communicating with an external switch 234, which could be integrated into a heating coil 236 of the water heater 202 as shown in FIG. 2B. Optionally, controller 216 could also be programmed to interrupt gas flow to the coil.

As shown in FIG. 2A, controller 216 includes a manual reset button 234 that causes controller 216 to communicate with first 208 and second valve actuators 210 to open the valves 204 and 206 when reset button 234 is engaged. Reset button 234 also preferably causes controller 216 to communicate with the switch 232 to resume providing electricity to water heater 202.

System 200 includes a third sensor 238 configured to monitor a temperature of inlet pipe 224. Thus, for example, the third sensor could monitor the temperature of the fluid in the pipe, and send a signal to controller 216 if a temperature reaches a predetermined threshold (e.g., less than 2° C.). This is advantageous, as it allows the controller to shut down the water heater if freezing conditions are detected in the inlet pipe. Third sensor could alternatively be configured to monitor a pressure of the inlet pipe 224.

As shown in FIG. 2B, system 200 could also include a third valve 242 operably connected to a third valve actuator 240, which opens the drain pipe 218 when a signal is communicated from controller 216. The addition of the third valve is advantageous as it allows fluid to drain from the water heater when the water heater is shut down, and thereby lessen any potential leaks. Controller 216 could be further be configured to control additional valves and sensors (not shown).

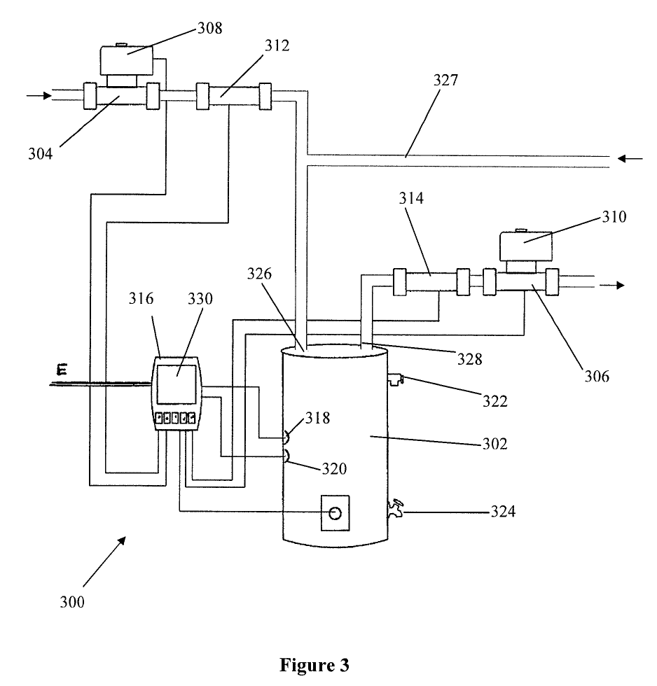

In FIG. 3, system 300 shuts down water flow to water heater 302 upon detecting a leak, and includes first 304 and second valves 306, first 308 and second valve actuators 310, first 312 and second sensors 314, and controller 316. System 300 further includes third 318 and fourth sensors 320 disposed on the water heater that measure the pressure and temperature, respectively, within water heater 302. While third 318 and fourth sensors 320 are shown disposed on the water heater, one or both of the sensors could be disposed within the water heater or adjacent to water heater such as on a fluid conduit for example. The additional sensors are advantageous as the sensors could monitor parameters within the water heater, within the fluid conduit, or other desired locations. Thus, for example, the additional sensors could be disposed within the cold water inlet to the water heater and detect for potential freezing conditions within the fluid conduit.

Water heater 302 includes blowout valve 322 and drain pipe 324. Water heater 302 also includes an inlet pipe 326 and an outlet pipe 328. Inlet pipe 326 is bisected by hot water recirculation pipe 327, which includes a recirculating pump (not shown). Such recirculating pump could be operated autonomously or in conjunction with system 300. For example, controller 316 could optionally communicate with the recirculating pump and shut off the pump when controller shuts down water flow to the water heater. First valve actuator 308 is operably connected to the first valve 304 and automatically opens or shuts the valve when a signal is received from controller 316. Likewise, second valve actuator 310 is operably connected to the second valve 306 and automatically opens or shuts the valve when a signal is received from controller 316. First 312 and second sensors 314 operate to measure the amount of fluid flow through the inlet pipe 326 and outlet pipe 328, respectively.

Controller 316 receives a signal from each of the first 312 and second sensors 314, and controllably communicates with first 308 and second valve actuators 310. Controller 316 is preferably programmed to communicate with first 308 and second valve actuators 310 to shut the first 304 and second valves 306, respectively, when a flow difference of a defined threshold is detected between the flows of water into and out of water heater 302. In addition, controller 316 is preferably configured to shut the first 304 and second valves 306 when the pressure is greater than a threshold of blowout valve 322. Controller 316 is further configured to shut the first 304 and second valves 306 when the temperature sensor detects a temperature within the water heater that is greater than a defined threshold, including for example the temperature ranges discussed above. Controller 316 further includes display 330 to apprise a user of the status of system 300.

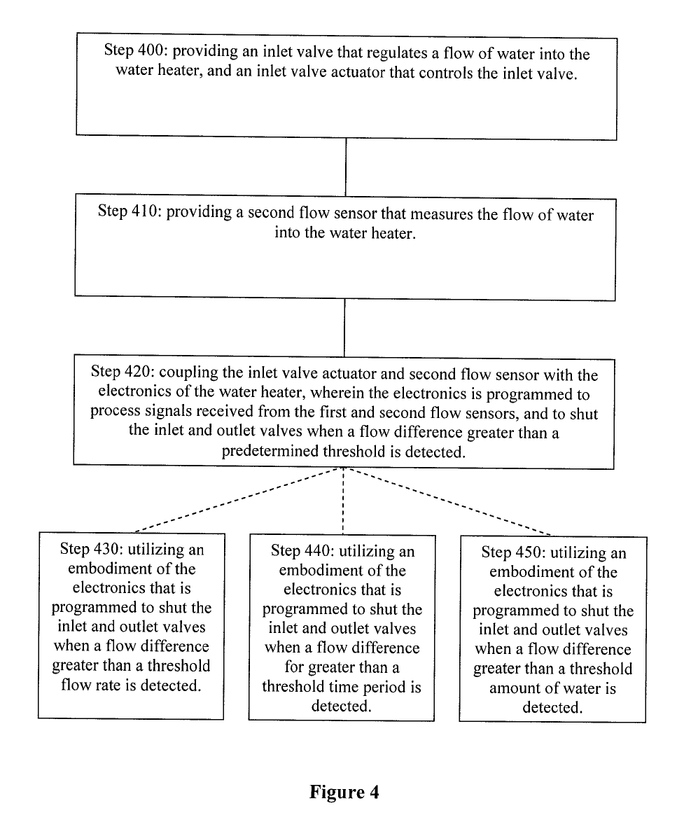

In FIG. 4, a method is disclosed of retrofitting a tankless water heater coupled to an outlet valve, a first flow sensor, and electronics that controls flow to the water heater, and optionally having an outlet valve actuator. An inlet valve that regulates a flow of water into the water heater, and an inlet valve actuator that controls the inlet valve, are provided (step 400). A second flow sensor is also provided that measures the flow of water into the water heater (step 410). The inlet valve actuator and second flow sensor are coupled with the electronics of the water heater, with the electronics being programmed to process signals received from the first and second flow sensors, and to shut the inlet and outlet valves when a flow difference greater than a predetermined threshold is detected (step 420) including for example, at the tank or coil in a tankless system. Optionally, an embodiment is utilized in which the electronics is programmed to shut the inlet and outlet valves when a flow difference greater than a threshold flow rate is detected (step 430). An embodiment could also be utilized in which the electronics is programmed to shut the inlet and outlet valves when a flow difference for greater than a threshold time period is detected (step 440). A further embodiment could be utilized in which the electronics is programmed to shut the inlet and outlet valves when a flow difference greater than a threshold amount of water is detected (step 450). These steps could be implemented in any suitable order, including but not limited to that shown in FIG. 4.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for shutting down water flow to a water heater, comprising:
a first valve and a second valve;
a first valve actuator that operates the first valve, and a second valve actuator that operates the second valve;
a first sensor that measures a flow of a water into the water heater, and a second sensor that measures a flow of a water out of the water heater; and
a controller that receives a signal from each of the first and second sensors, and controllably communicates with each of the first and second valve actuators.

2. The system of claim 1, further comprising a third sensor that detects temperature, and is disposed on the water heater.

3. The system of claim 1, further comprising a third sensor that detects pressure, and is disposed on the water heater.

4. The system of claim 1, further comprising a third sensor that detects temperature, and a fourth sensor that detects pressure, wherein each of the third and fourth sensors is disposed on the water heater.

5. The system of claim 1, wherein the controller is programmed to shut the first and second valves when the controller detects that a flow difference between flows of water into and out of the water heater is greater than a threshold flow rate.

6. The system of claim 1, wherein the controller programmed to shut the first and second valves when the controller detects that a flow difference between flows of water into and out of the water heater occurs for greater than a threshold time period.

7. The system of claim 1, wherein the controller programmed to shut the first and second valves when the controller detects that a flow difference between flows of water into and out of the water heater occurs for greater than a threshold amount of water.

8. The system of claim 3, wherein the controller is programmed to shut the first and second valves when the pressure is greater than a threshold of a blowout valve disposed on the water heater.

9. The system of claim 2, wherein the controller is programmed to shut the first and second valves when the temperature is greater than a threshold less than 100° C.

10. The system of claim 2, wherein the controller is programmed to shut the first and second valves when the temperature is greater than a threshold less than 120° C.

11. The system of claim 1, wherein the water heater has a storage tank.

12. The system of claim 1, wherein the water heater is tankless.

13. The system of claim 1, wherein the controller is programmed to interrupt a flow of gas to the water heater when the controller shuts the first and second valves.

14. The system of claim 1, wherein the controller is programmed to interrupt electricity to the water heater when the controller shuts the first and second valves.

15. The system of claim 1, wherein the controller is user-pluggable into a power grid.

16. A method of retrofitting a tankless water heater coupled to an outlet valve, a first flow sensor, and electronics that controls flow to the water heater, and optionally having an outlet valve actuator, comprising:
providing an inlet valve that regulates a flow of water into the water heater, and an inlet valve actuator that controls the inlet valve;
providing a second flow sensor that measures the flow of water into the water heater; and
coupling the inlet valve actuator and second flow sensor with the electronics of the water heater, wherein the electronics is programmed to process signals received from the first and second flow sensors, and to shut the inlet and outlet valves when a flow difference greater than a predetermined threshold is detected.

17. The method of claim 16, further comprising utilizing an embodiment of the electronics programmed to shut the inlet and outlet valves when a flow difference greater than a threshold flow rate is detected.

18. The method of claim 16, utilizing an embodiment of the electronics programmed to shut the inlet and outlet valves when a flow difference for greater than a threshold time period is detected.

19. The method of claim 16, utilizing an embodiment of the electronics programmed to shut the inlet and outlet valves when a flow difference greater than a threshold amount of water is detected.
